(19) United States
(12) Patent Application Publication
(10) Pub. No.: US 2010/0294877 A1
(43) Pub. Date: Nov. 25, 2010

(54) VTOL lifting body flying automobile

(76) Inventor: Laurentiu Jianu, Ridgewood, NY (US)

Correspondence Address: Laurentiu Jianu, 927 Onderdonk Av., Ridgewood, NY, 11385, US

(21) Appl. No.: 11/240,913

(22) Filed: Sep. 30, 2005

(51) Int. Cl. B64C 37/00; B64C 29/00; B62K 21/12

(52) U.S. Cl. 244/2; 74/551.1

(57) ABSTRACT

This apparatus is a new VTOL roadable aircraft having fore and aft sections joined by a seating midsection; with compact inlets built into its fuselage, also pairs of flight stabilizing surfaces and tail fins; the fuselage structure being a Lifting Body that provides aerodynamic lift during both forward flight and vertical descent; provided with intake chambers containing propelling surfaces rotating on longitudinal axis in opposite senses, and external pairs of swiveled nozzles producing thrust vectoring; these nozzles using conventional devices and having spins directed by original controls of corresponding identical movement directions; with standard automobile equipment integrated with the vehicle compact design and dimensions, making it compatible for road transport and enabling direct transitions to flight mode; and safe landing systems for emergencies are provided with half the technology being off the shelf devices as those in use by NASA and the US Airforce.

### CROSS REFERENCE TO RELATED APPLICATIONS

Not Applicable.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of VTOL aircraft and more specifically to Roadable VTOL vehicles.

For more than half a century there have been inventions and vehicles aiming to function both in the air and on roads in continuous transit from one environment to the other. Commonly known as flying cars, all have encountered major obstacles in attaining their purposes due to requiring interruptions for the removal or addition of structures specific to one operational regime such as wings, prior to entering the next functional medium. Safety was a major issue compromised because of employing externally exposed, large size propelling surfaces during road traffic. Crafts using ducted propulsion systems suffered from either oversized structures rendering them incompatible to function on road parameters and infrastructures, or due to using smaller thrust mechanisms, became inadequate to produce and sustain flight.

Another factor that contributed to these attempts lack of technological or commercial achievements was the absence of sufficient aerodynamic characteristics of their outer structures for stable flight, and on others the negative interference of flight features with effective road dynamics and protocols. Critical in almost all prior crafts was their inability to perform fast, tight, maneuvers during both air and road bound activities which are essential in the approach, departure and transfers in three dimensional operational envelopes demanded in urban airspace environments. In addition, some machines had separate dual controls and related components for each of the operational regimes. Others were made very complex by being equipped with a single control set dominant in either flight or road functions and had to trade off, shift multiple connections and parts to the secondary, less efficient and less reliable engineered platform of the particular environment. Most prior attempts of thrust vectoring applications involved a large number of flow deflecting surfaces with limited motion ranges, and many even used variable directional inlets but their effects were flows dispersion, air stream decay and also induced stalling during propellers shifting attack angles at the transversing of three dimensional planes.

Among relevant prior art consisting of patents and built machines that have at least one major characteristic close to this invention is the helicopter. In all its versions, VTOL is accomplished by way of rotary wings moving in an approximately horizontal plane. However, size of the blades which are also exposed externally endangers the safety of aircraft, surrounding structures and pedestrians thus prohibiting helicopter use on roads. Paul Moller, U.S. Pat. No. 5,115,996 achieves VTOL and Thrust Vectoring with multiple ducted propellers located on the sides of a fuselage. Aside from craft dimensions banning its use on public roads, it employs eight engines, large number of deflector vanes and multiple highly complex control and navigation computers. High costs of building and maintaining such aircraft, also difficulties of coordinating numerous components render the airflow management ineffective and mechanical parts processes unreliable with its current state of technology.

David Budworth, U.S. Pat. No. 3,494,575 and Joachim Lay, U.S. Pat. No. 5,141,173 both applied multiple ducted lifting fans placed laterally and more, aiming for VTOL capability on car based platforms. On close reviews, their technologies reveal lack of flight characteristics, unsafe arrangements of propulsion units and propellers of insufficient sizes driven by incompatible high output powerplants. Youbin Mao, U.S. Pat. No. 6,824,095 B2 and Larry Long, U.S. Pat. No. 6,745,977 B1 present similarities of VTOL and Thrust Vectoring devices on cars with propellers located in fore and aft compartments. Their ducted rotors shapes and orientations show limited ranges for maneuvering, have inadequate vehicles three dimensional balance, and due to inlets schematics have small horizontal thrust capabilities.

The Harrier Jump Jet and Joint Strike Fighter are significant for their Thrust Vectoring nozzles, but these embodiments have limited directions and ranges of motions. Nozzle shapes, placements, orientations and ways of applying them lead to impractical use in extended durations of horizontal thrust, also being inconsistent for fast, tight maneuvering. Aircrafts built by NASA, such as M2-F2, X-24A, X-38 and HL-10 established validity of Lifting Bodies and unpowered landing abilities, however they were not roadable, without VTOL capacity and used airflow deflecting surfaces which resulted in slow maneuverability with extensive clearance areas. Aircraft F-111 and most US Airforce fighter jets proved landing impact absorption devices and pilots egress systems reliability.

Equipment made by (among other manufacturers) Martin Baker Aircraft and B.F. Goodrich Aerospace was applied to saving pilots but not the aircrafts. Their different mechanisms were not employed in combinations to provide survival of both craft and occupants and were not adapted to civilian operations. Control systems used by airplanes in general, also those in helicopters, are engineered for airflows deflecting surfaces which produce shifts in crafts dynamics. The shortcomings of these devices are resulted from lack of intuitive motions, not corresponding directly to vehicles trajectories, having multiple locations that impose raised monitoring strains on pilots, in addition to complex training and low comfort level to operate as compared to the ease of car and motorcycle handling.

Low reliability of individual mechanisms during both flight and road regimes; difficulty of controlling them in varied conditions; inefficiency of combinations of different compatibility technologies or dominance of one operation shortchanging the other; inadequate safety to occupants and vehicle in the air together with ground transports, each prior craft has at least one major failure from the criteria listed and is the current overall state of these classes of machines.

### DESCRIPTION OF PRIOR ART

Disadvantages of prior art are due to lacking components and ways for sustaining lift or for fast recovery from situations of vehicle siderolled positions, also of unsafe handling at high incidence angles which lead to fore or aft induced craft dives, the conclusions being based on shown unsatisfactory thrust vectoring ranges and vectors in three dimensions.

A major disadvantage has the type of mechanism made of airflow deflecting multiple vanes or slots used to perform thrust vectoring. Large mechanical stresses on these small size parts and on their support structures require constant maintenance, and performance of such devices has low efficiency because of resulted divergent, turbulent outflows. One of the effects is the stringent requirements placed on coordinating a plurality of substreams, often done by complex, computer networks.

A critical disadvantage of prior technology is the limited ability to manage loads shifts on aircrafts, especially rapid occurring ones in three dimensions. To compensate, support and accessories were applied in order to obtain multiple feedback, analyzers, corrective actuators and more. All these increase craft building costs and complicate handling with each added part, including raised demands and discomfort to the pilot-driver attention levels.

Another shortcoming of most VTOL aircrafts, based on presented capacities, is the inability to fit on roads parameters. Not having compact structures, including propulsion units sizes incompatibility to lane width, eliminates them from road transit.

An inadequacy of many Thrust Vectoring vehicles is their maneuvering ability. Employment of pivotable nacelles or similar mechanisms limits them to slow transitions between the various orientations needed, and restricts those components movements ranges. Aside from considerable clearance areas demanded for these external or internal structures motions, considerable space is necessary for unobstructed air intake during shifts in incidence angles. At higher rates of propelling surfaces axis alterations flows misalignment to propellers axes occurs inducing stall to inlet sections. Turbulence, slipping off the streams are conditions produced inside the compartments enclosing the propellers, causing the overall safety and efficiency to be compromised.

Lacking sufficient balance qualities is an issue for a lot of the disclosed flying cars. Configurations with numerous airflow deflecting surfaces have lead to obstacles of synchronizing not just the terminal parts, but their connective networks of many actuators, transmissions, engines regimes and controls. Attempts in multiple substreams divisions and accordingly micromanaging them only multiplied the possibility of malfunctions with each added part. Instead of a stable aircraft, a highly sensitive platform to many sources had resulted, exposing it to added influences and vulnerable to the multiple factors interfering with one another. These machines have proven decreased tolerance to small mechanical misalignments, to outer cross directional airflows, and produced imbalancing effects, being rocked forward to aftward, also induced lateral ‘wobbling ’ motions.

Insufficient versatility is the weakness of other prior inlets technologies. Both vertically fixed and pivotable structures have plane of openings restrictions caused by shapes, locations and orientations. Known roadable aircrafts are equipped with openings of single plane orientations thus resulting in absence of ruggedness, and lacking reliability to successfully handle multi directional, diverse pathways or non streamline inflows. Almost all inlets show strong negative effects when airstreams become non parallel to rotors axes, and have very reduced functions in a rapidly changing, wide operational envelope that is needed in the transiting of urban environments air space.

Deficiency of flight stabilizing features is the remaining prior art elementary criteria for disqualification. As predominant car operating platforms with secondary or minimal aerial transport capabilities, these machines rely too extensively on propulsion devices to attain some measure of multiple directions dynamics, but actually only produce restricted stability in three dimensional trajectories. Ineffective stabilizing equipment and absence of compensatory configurations are accompanied by low aerodynamic characteristics presented by the road vehicles outer structures together with that of main systems showed arrangements. Just as important, these disclosed vehicles do not have enough lift producing features, do not gain effective lift in forward motion, nor are capable in power out situations to slower descent rate for reasonable crash survival.

The resulted technological embodiments are automobiles with some minor, occasional and limited air space operativeness.

### OBJECTIVES OF THE INVENTION

The primary object of the invention is to provide a simpler, robust, and more efficient roadable aircraft than existing versions by using engineering tactics and techniques of reduced number of components, lesser moving parts and minimizing mechanical interactions together with their decreased aerodynamic interferences.

One objective of the invention is ease of operation by increasing pilot as driver comfort, this being based on highly ergonomic input processes, intuitive controls, non complex training skills, and vehicle responsiveness matching handling dynamics instead of the operator actions having to adapt to the mechanisms logistics.

Another object of the invention is lower maintenance costs and turnover time due to non complex computer systems, and using less numbers of parts of propulsion related structures.

A further object of the invention is raised convenience to its users by enabling direct transitions, uninterrupted between regular road transport and flight functions; being attained by the craft size, high maneuverability, motor vehicle equipment and multiple safety features.

Yet another object of the invention is reaching the highest reliability, contributed by craft rugged characteristics, fast responses and its capacity to handle varied airflows and adverse environmental conditions.

Still additional objective of the invention is accomplishing the most feasible stability and safety in its class, as resulted from craft flight characteristics in combination with back up, emergency mechanisms.

Another objective of the invention is versatility, having adaptive abilities to diverse roles to shift functions between personal use, elevated structures utility maintenance, emergency services, military and others.

An additional object of the invention is creation of enterprises involved in manufacturing, servicing stations, training schools, through achieving on multiple fronts technical superiority, by its significantly increased convenience and ease of operation, also providing higher benefits in other regards over the competition.

A further object of the invention is the application in new ways, or adapting of current mechanisms, of unpowered safe landing technologies to its operations, the types of devices which are validated and in use by NASA and US Airforce.

Yet another object of the invention is having alternative configurations to accommodate a frequent urban environment transit, by enabling separate octane ratings of plural fuel tanks, dual fuels engines, or using different octane engines and compensatory accessories in order to refuel at regular car stations.

Other objects and advantages of the present invention will become apparent from the following descriptions taken in connection with the accompanying drawings, by way of illustration and example an embodiment of the present invention is disclosed.

### ADVANTAGES

An important advantage of the present invention is the employment of fixed air inlets, thus the aircraft keeps stable rapports between aerodynamic forces, factors on the inlets and loads shifts in all three dimensional planes. Balance is easily obtained by compensating with fore-aft nozzles, their movements being direct and parallel with outflows vectors aligned on paired three dimensional axes.

Another advantage is that intakes shapes, locations, and orientations are detailed to handle different directions of airflow vectors while minimizing propellers vortices and slips. This superior flows management is due to compounded effects of each inlet chamber having partial propulsion surfaces located in the half exposed sections, and the rest of propellers located in the fully enclosed sections.

An additional advantage is craft composition of minimal number of moving propulsion structures and related mechanisms, resulting in major reduction of electronic or computerized controls and systems monitors. Also simplified are interactions between systems by the reduction of intermediary electronic processes which lowers maintenance costs compared to other complex machines. Resulted are lesser numbers of potential malfunctions and failures that occur to other vehicles containing high number of moving components.

Yet another advantage is the essential simplicity of technology, of the overall aircraft rendered ruggedness, thus less influenced by and more tolerant to adverse conditions. This is especially useful since the craft needs to handle wide angular differences and shifts in three dimensional operational envelopes, including engaging in tight and fast maneuvers during urban roads and airspace transports.

Major benefits of using the least feasible number of moving parts eases operator control inputs, require less time, less energy and attention. Low mental solicitation of pilot is resulted from lower number of control parts, lessening of intermediary maneuvers and produces increased levels of operator comfort and enjoyment.

Higher stability of aircraft is significantly due to the swiveling nozzles sets rapports to mass center, their midrange location being almost superimposed on MC. Vehicle positions during nozzles motions have smooth transitions on three axes even though exit flows have variable transfers. Exit flows alignments having preset spin ratios can constantly balance craft orientations directly in all operational modes by intuitive handling and maneuvers.

Optimal structural nozzles shapes of partially barrel shape, partially half spherical characteristics give both dynamic integrity and airflows enhanced management abilities. Their three dimensional thrust vectoring match controls movements while lessen mechanical stresses on involved components. Nozzles structures enable continuous equal pressures at openings sites, provide lowest dispersion effects, reduce peripheral turbulence and output a higher thrust gradient than other mechanisms.

Another superior edge of this VTOL aircraft over prior art is given by the intake compartments and their contained propellers. By enclosing about half of each chamber aft section three dimensionally, the propellers molded shapes, angles and air streams interactions produce significantly less acoustic pollution. Propellers rotation on craft longitudinal axis exposes them to approximately half external interactions with ambient air mass in those directions, as a result vibrations are mostly absorbed internally using conventional buffeting materials or equivalent means.

An advantage gained by the main embodiment but not limited to it is that this flying automobile size has approximately a width of 7 feet, length of almost 15 feet and height approaching 7 feet. As a result the vehicle is fully compatible to function on regular roads without any alterations involved to structures or processes. Adequate clearance zones and regulations in urban environments already exist in helicopter designated proximal sites, but the critical benefit of operating as a roadable vehicle in continuous transport gives this craft increased convenience and additional locations of departure and arrival in cities boundaries.

Significantly improved over other aircrafts are this craft fuselage and flight surfaces with full lifting body characteristics. They provide lift during horizontal flight and also in emergency of power failure still contribute to critically slowering descent. Further increased safety over other aircrafts is achieved by being equipped with separate, proven emergency systems of active deceleration and impact absorption. These back ups are stored compactly inside the craft in immobile states during normal functions of vehicle, are based on tests and current uses by NASA and US Airforce, having high reliability, low weighs and requiring only occasional maintenance.

### Primary Elements:

The combination of Lifting Body shape and related flight surfaces with inlets optimal orientations and placements.

Superior employment of Thrust Vectoring three dimensional swiveled nozzles shapes, motions and arrangements.

Full road transport capability and direct transitions enabled by the standard automobile equipment, craft compact design and compatible dimensions.

Use of Emergency Safe Landing systems in new ways, particularly applied to a VTOL aircraft, to a Thrust Vectoring vehicle or Roadable Aircraft.

The emergency systems adapted characteristics of shapes, locations and loads ratings functionality.

Combined application of two or more back up conventional technologies in new effective operations for an aircraft and occupants survival based on high crash worthiness.

Synchronized precise activation of Unpowered Landing mechanisms in three different sequences, based on critical altitudes ranges of occurring emergencies.

Simpler and easier controls than of any VTOL aircraft, due to mechanisms ergonomic shapes, placements and optimal motions and connections.

Low operator stress in handling the craft resulted from very similar control processes for both flight and road bound modes.

Highly intuitive vehicle navigation, based on its three dimensional maneuvers corresponding to operator hands directional actions.

### Secondary Elemements:

Convertible cabin three sided enclosure provides versatility in different weather conditions for increased comfort and enjoyment, the technology being of convertible rooftop car industry.

Craft scalable to increased sizes and loads maintains compatibility with road transit operations, infrastructures and regulations.

Versatile cabin space of scaled versions accommodate air taxi functions, and removal of aft few seats can adapt the craft for emergency services, elevated structures utility maintenance, valuable cargo and others.

The vehicle has also military applications by adapting it to unmanned missions for hostile environments, or by miniaturization due to its stealth abilities the machine can perform reconnaissance.

For a high service ceiling the cabin can be made fixed pressurized, another option consists in equipping craft with compact, upward rabatable wings for longer flight ranges.

### BRIEF SUMMARY OF THE INVENTION

In accordance with a preferred embodiment of the invention is disclosed a VTOL machine incorporating a Lifting Body fuselage; with tandem seating located inside a convertible or fixed cabin; three dimensional Thrust Vectoring being performed by wide range swiveling nozzles; and having systems provided for Unpowered Safe Landing such as employed by NASA and US Airforce; also with simple controls and intuitive handling applied for operator comfort and ease; with characteristics of compactness, parameters and motor vehicle equipment engineered for road transport and direct uninterrupted transitions to airspace; the improved and optimally combined technologies making this vehicle a new Flying Automobile.

### BRIEF DESCRIPTION OF VIEWS OF THE DRAWINGS

The drawings constitute a part of this specification and include exemplary embodiments to the invention, which may be embodied in various forms. It is to be understood that in some instances various aspects of the invention may be shown decreased or enlarged to facilitate an understanding of the invention.

In the drawings:

FIG. 1A is a top view of the main embodiment showing an open cabin with tandem seating and flight related features of fuselage, intake openings, stabilizing surfaces, tail fins, nozzles pairs and their formation.

FIGS. 1B and 1C are side view and respectively front view of vehicle from FIG. 1A, showing same structures and road traction three wheels arrangement.

FIGS. 2A, 2B and 2C are top, side and front views of the aircraft shown in FIG. 1 series, having details of road transit equipment of collision protective bars, head, signal and stoplights, tail exhaust pipes, windshield wipers, retractable rear view mirrors, dual joints folding lightning rod, also of intake chambers bottom drainage openings, the steerable frontal wheel and license plate.

FIG. 3A is a side view of the convertible cabin with its support structures of variable bars having collapsible joints, and is shown after deployment from aft storage compartment with components including windows flexible frames built into the canvas, positional locking triggers and Plexiglas type, swinging window parts.

FIG. 3B is a side view of cabin fully deployed of FIG. 3A and shows its outer surfaces details.

FIG. 4A is a top view of the cabin presented in FIG. 3A, and shows identical parts.

FIG. 4B is a top view of FIG. 3B showing the same elements.

FIGS. 5A and 5B are top and side views of vehicle six seater alternate embodiment with fixed cabin, based on the images in the FIGS. 1A through 2C, having details of increased dimensions and proportionally larger devices.

FIG. 6 is a perspective view from a partial aft angle of the main embodiment, having the closed cabin that is shown in FIGS. 4A through 5B.

FIG. 7 is a perspective view from a partial front angle of another alternate embodiment of an rescue UAV with rabatable wings.

FIG. 8A is a front view of main embodiment from FIG. 1C presenting four emergency safe landing systems deployed for unpowered descent and aircraft position together with its approach vector.

FIG. 8B is a side view of identical elements from FIG. 8A and details the rabated positions of stabilizing surfaces, activated minirockets, wheels struts with hydraulic telescopes, inflated airbags and their releasing structures.

FIGS. 9A, 9B and 9C are aft, side and respectively top views of control mechanisms, critical instruments displays, and operator positional rapports to these components.

FIGS. 10A, 10B and 10C are all aft views of controls set showing the three axes of movements, their corresponding dimensional spin senses and the three primary transmissions stages responsible for subsequent connections underneath the floor board mast.

FIG. 11A is a side view of FIG. 10A showing controls variable positions and movements of the roadable aircraft in VTOL, hover, breaking and thrust maneuvers.

FIG. 11B is a top view of FIG. 10B presenting controls position and motion for craft in steering maneuver towards right side.

FIG. 11C is an aft view of FIG. 10C, having controls positions and actions during vehicle performing roll and counter roll operations.

FIG. 12 is a frontal view from FIG. 1C showing craft during both road and flight modes turning towards right side, the steerable front wheel simultaneously active with the fore nozzles positional changes and resulted airflows formation directions, also being similar during roll, counter-roll functions.

FIG. 13 is a side view from FIG. 1B having variable nozzles positions with their paired outflows formations, which correspond to operations of breaking, VTOL and hover, thrust, also in recovery actions from induced nose and tail dives.

FIG. 14 is a top view matching FIG. 1A in presentation of same elements as FIG. 13, of outflows angular orientations during vehicle different functions, which are valid for both road and aerial transport activities.

### DETAILED DESCRIPTION OF THE PREFERRED EMBODIMENT

Detailed descriptions of the preferred embodiment are provided herein, it is to be understood however that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

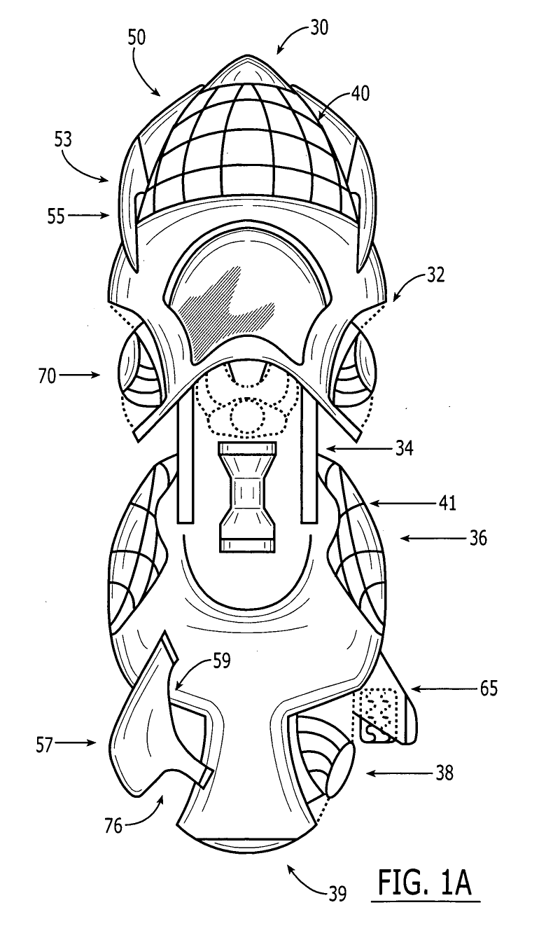

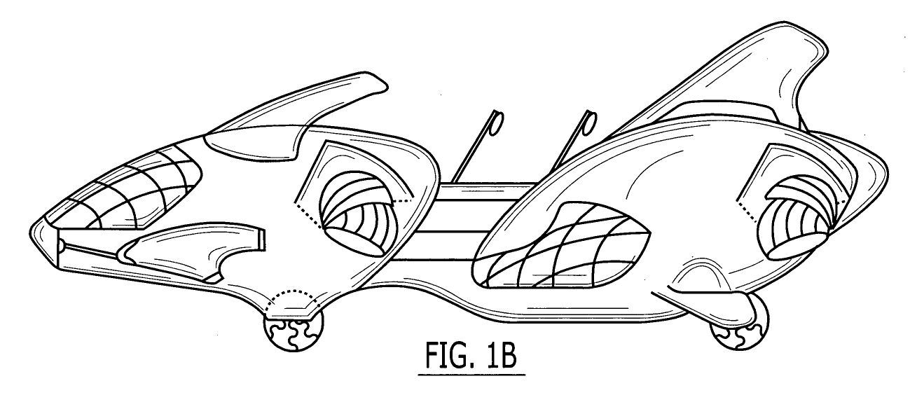

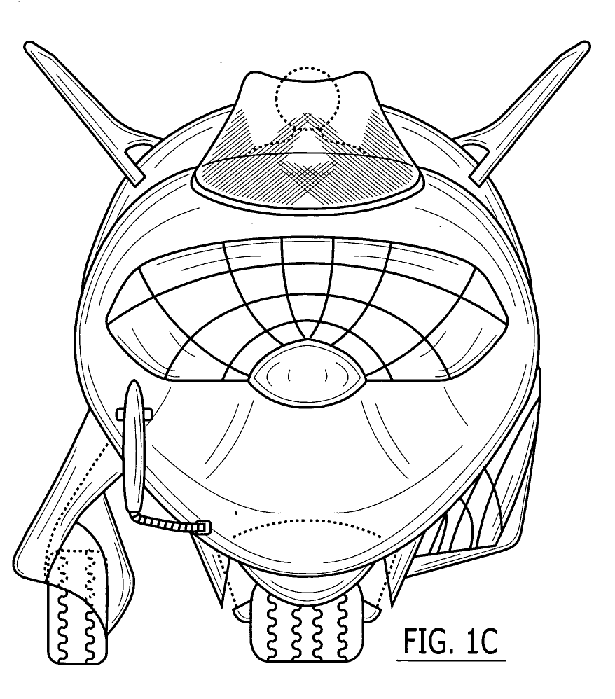

The invention will now be described by way of example with the aid of the accompanying drawings. In the images, a new and improved Vertical Take Off and Landing Lifting Body fuselage is shown in FIGS. 1A, 1B,1C, with integrated technologies of a Flying Automobile. All external structures shapes and placements are optimal for lift producing effects on a wingless aircraft, with the fuselage composed of two almost ovoidal shape sections 32, 36, 38, joined in between by a central 34 seating section. As seen from a frontal and also side view the air lifting characteristics are clearly defined, providing high aerodynamic balance on the three axes while reducing descent rate for landing operations, and reduced drag is contributed by aircraft extremities 30, 39, which are aligned on its longitudinal axis.

Intake openings consist of one unit built compactly into the fuselage in the frontal section 40, its shape and orientation capable of processing multi directional, varied and turbulent inflows. Two intakes on the aft section 41 have partially forward, upward, and lateral orientations of maximum angles combinations, measured for three planes wide angular range inflows as is the frontal unit. Protective grates on the openings are engineered for both structural and aerodynamic benefits and contribute partially to boundary layers effects and to inflow chambers three dimensional versatility in managing even turbulent airstreams.

Pairs of frontal stabilizing surfaces 53 each with two units are connected 50, 55 on each lateral, their function being to balance to a high level craft positions and trajectories during vertical and horizontal flight, while reducing their own structures drag coefficient. Dual tail fins 57 in a ‘V’ formation serve as double stabilizers in vertical and horizontal flight, having connectors 59 of low cross directional drag. Their profile resembling a shark fin also contribute in raising the craft lifting ability during forward movements.

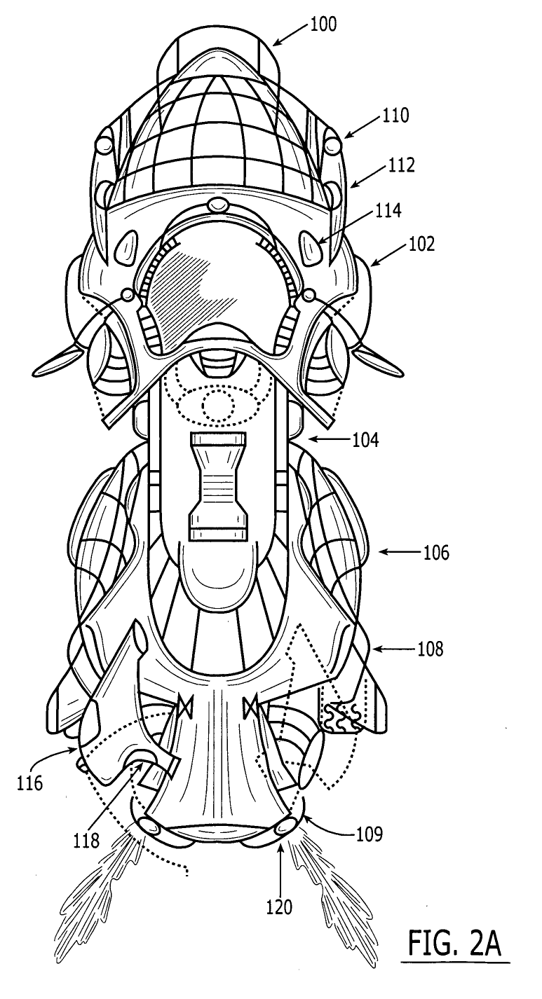

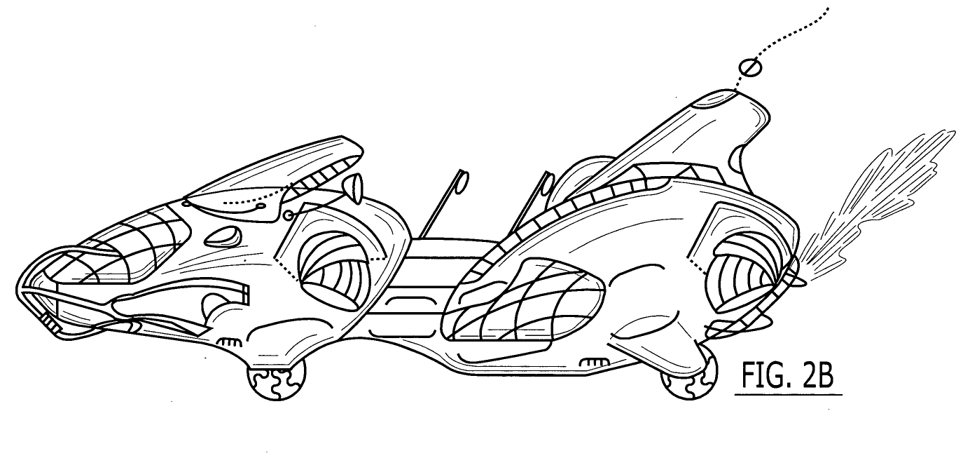

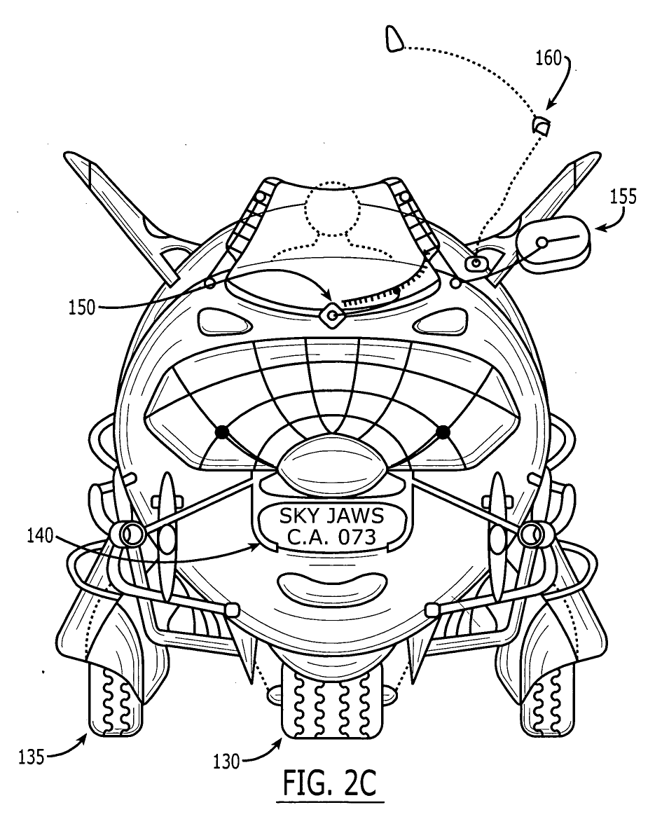

The aircraft is equipped with a full range of air transport conventional technologies but customized to its characteristics, in FIG. 2A are seen some of the specific features such as: water drainage orifices with pivotable covers located below the inflow chambers; nose tip placed multi vectorial medium range radar; night time flashing lights 112, 116 and head, top, and bottom lights; aftward placed exhaust pipes; mid section contained fuel tanks; wheels aerodynamic masts; and in FIGS. 2B, 2C is a dual jointed collapsible lightning rod 160 among other structures.

Four sets of swiveled nozzles having three dimensional motions are producing thrust vectoring of the aircraft. These systems wide ranges of spins provide high maneuverability in multiple directions, and each set is composed of two units that are located on the sides of the craft, two pairs placed on the fore section 70 and the other two on the aft section 76 of the fuselage. Each pair of nozzles consists of one unit through which the airflow is fed from the chamber and positionally spins only transversally, and a second unit attached continuously to the first one follows it outerly in placement and orientation having longitudinal plane rotations. The connecting structures between outports two units and to vehicle proximal sites are mobile, variable positions parts of sliding and rolling devices of dual senses conventional mechanisms, and movements are performed by separate actuators for transversal and for longitudinal circular momentum.

Transversal moving nozzles are shaped almost bowl like with a circumferential lip oriented downward which surrounds approximately half of its paired unit (of longitudinal roll) surface resembling a bell shape. Exposed section from the preceding enclosure, this element has a barrel like geometry and its external opening faces downward close to the perpendicular. Each set of outports is configured to have the outer leading member with independent motion from its preceding member, with the inner lagging one continuously engaging transversally the displacement of its paired unit. Outports located in the fore section of craft are equipped with additional actuators activating only these elements during steering maneuvers, without involvement of aft outports. All longitudinal plane rotating nozzles are synchronized almost in parallel alignment without engagement of their preceding units, transversal plane units also have approaching parallel vectors but carry with their variations the longitudinal pairs due to conventional pull-push connectors and trajectory locks.

Road transport capabilities of the vehicle FIGS. 2A, 2B, 2C are based on standard systems of automobiles. Shown are multiple lighting fixtures 110, 114, 118, and customized features for increased protection and optimal functionality in both street and aerial conditions. Collision protective bars shapes and locations 100, 102, 104, 106, 108, 109 are intended for coverage of critical areas primarily, also minimizing their drag coefficient secondly. A three wheel pattern for traction provides good balance support with its fixed aft arrangement 135 and the frontal wheel 130 being wider and steerable by same controls and related mechanisms during both ground and flight maneuvers. Included among those standard devices are motor vehicle license plate(s) 140, windshield wiper 150, rabatable rear view mirrors 155 and others.

The images display accurately engineered proportional rapports of components to an average size individual and to road limitations, clearly seen are craft narrow width together with its compact superstructures. This vehicle has closely approximated dimensions compatible with road parameters, and approaches a length of about 5 m. (15 ft.), a width of almost 2.3 m. (7 ft.), and its total height no more than 2.3 m. (7 ft).

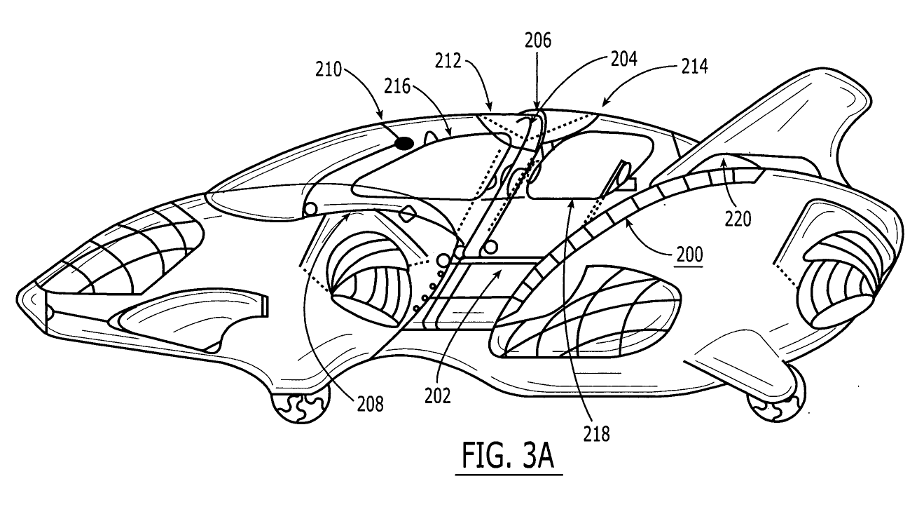

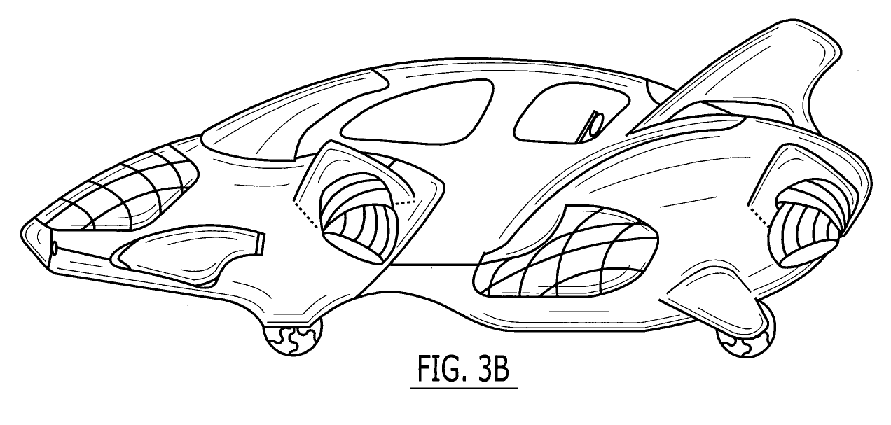

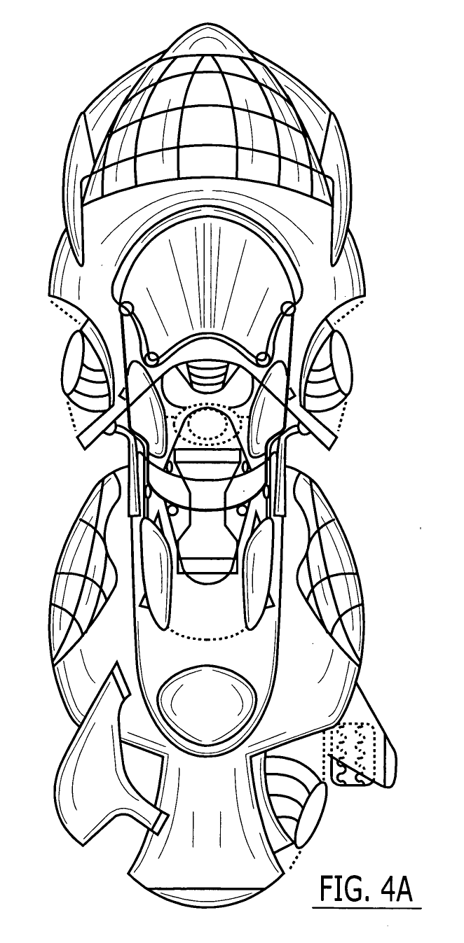

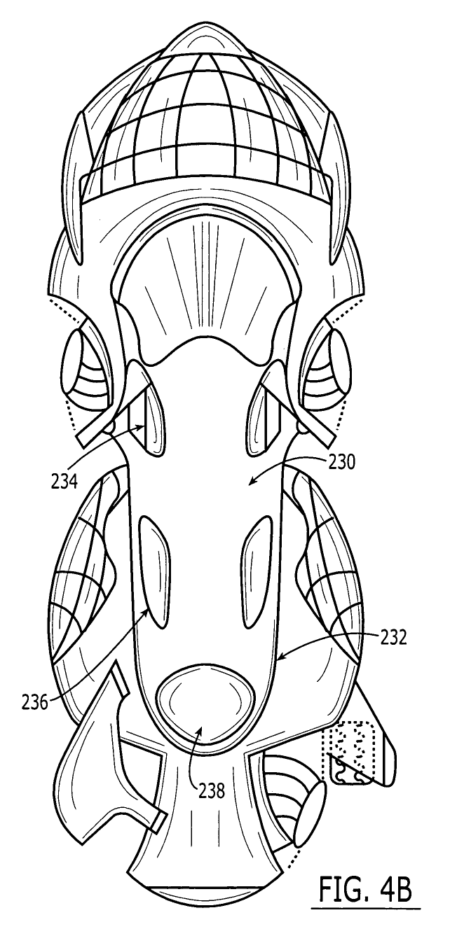

A three sided convertible cabin is intended for occupants increased comfort and enjoyment, but optionally a fixed cabin can be easily provided on the aircraft. Fully enclosing structures employ conventional car convertible top technology with some additions and release in two main stages FIGS. 3A, 3B, 4A, 4B with secondary steps accompanying them. First, rails 202 stored in vertical orientations in craft fore section spin upward and aftward thus locking in predetermined longitudinal positions, the deployment of one on each side of craft initiating an automated sequence. From aft section located storing compartment 200, arch shaped bars 204 slide forward on dual supports established tracks, pulling behind them a plied canvas material and release their own longitudinally oriented frame, followed by the forward directed folds and flexible frame 218. An aft segment of top side pivotable rods move upward and aftward, these being the parts from described retracted positions on the primary arched bar, also a rear viewing Plexiglas based window 220 is getting fully articulated into preset position at the end of this step. The above section moving canvas pulls within its surface preestablished hollow flexible frames 216 which are connected inward by rotational devices to transparent plastic window parts, at this point the whole section and its attachments being fully expanded.

The second main stage has the fore covering section arched bars 206 with lateral vertical arms and its following canvas surface deploying from same location as the first main stage, and is positioned underneath that previous segment layer upon its extension. The second portion of the conversion is of slightly smaller dimensions than the first, and as it moves forward on its own pivotated rods 208 that provide support on longitudinal expanded arms it triggers self locking positional contacts. Upon forward sliding on both laterals, the longitudinal arms unfold from their midsections devices that become rigid and fit on the windshield edges 210 due to matching frames shapes. At this time fore top side pivotable couplings extend forward from initial position of plied 212 closely to the primary arch shaped bars, and the lower rods rigid frames carry fore enclosing canvas, securing the parts into positions by means of pre established self triggering clutches and hooks.

These components pull simultaneously within their bodies fitting molds with collapsible joints that are connected inward laterally with variable clamps to transparent plastic window portions. Once the windshield edges are engaged by the designated frames, locations points are secured in place and the three sided convertible structure 230 is fully deployed compactly 232. Window elements that are hanging in slightly inward-aftward positions have built in string cables on two edges each or equivalent devices, for automatically get pulled in a partial transversally forward trajectory and fill the frames 234, 236, thus locking into margins by self tripping mechanisms, same being valid for the rear windshield 238.

Cabin retraction to open form and aircraft exiting are enabled when operator releases the locks on frontal windshield frame, allowing structural backtracking then flipping the same device of sequence initiation to reversed position. This produces automatic movements of components in reverse manner from the expansion, ending with the whole system inside the storing compartment.

### Alternative Embodiment

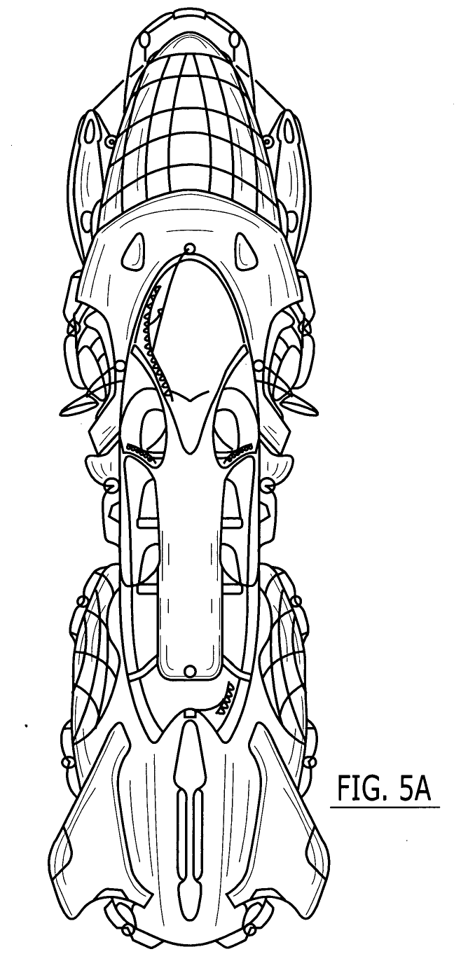

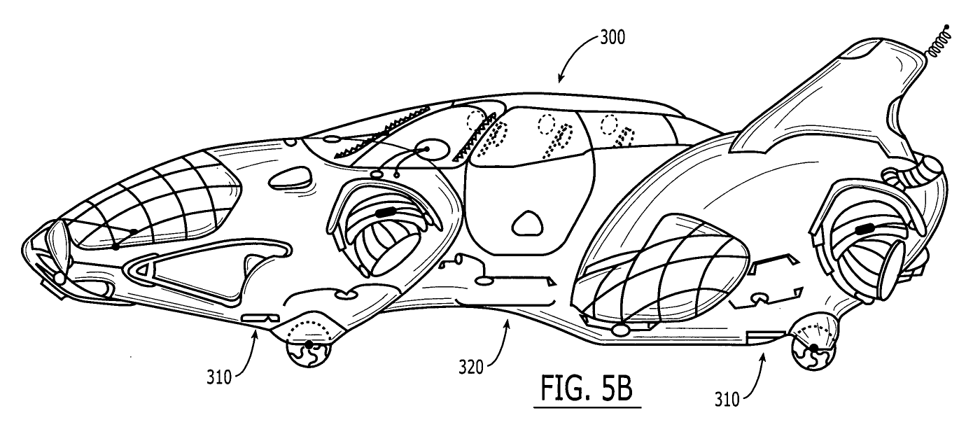

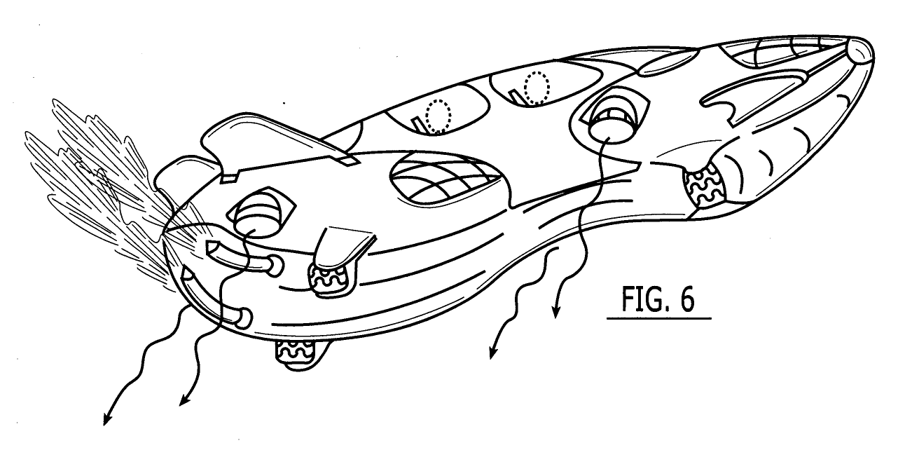

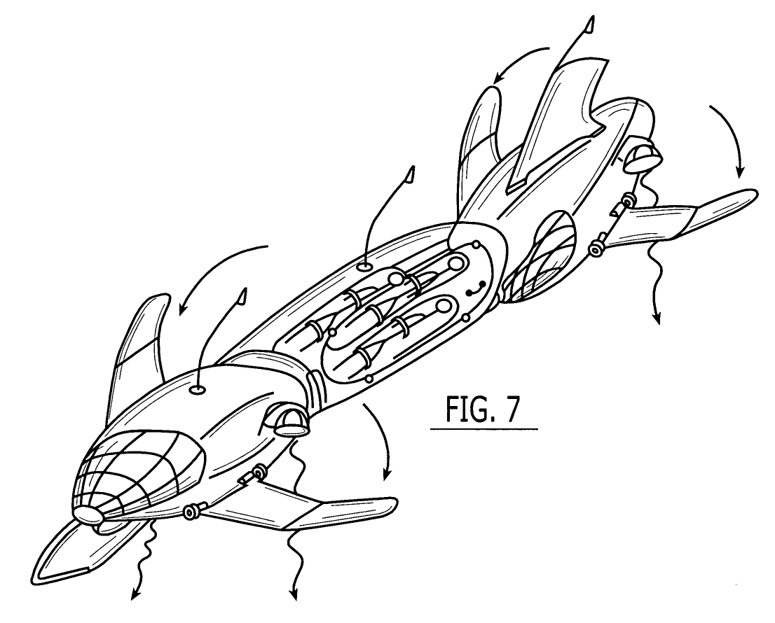

An Alternate Embodiment of the VTOL Lifting Body Flying Automobile is shown in FIGS. 5A and 5B with a fixed cabin. In two rows formation 300 carries up to six persons, with two powerplants aligned longitudinally inside the fuselage, and among previously described features are detailed the drainage openings 310, also the collision protection bars 320. Increased safety comprises a third drive shaft provided between two engines having individual coupling mechanisms to each rotor head or transmissions gear set boxes, intended as back up during one engine failure to transfer torque from the working one to the other, these devices being of conventional structures and functions. For situations of dual rotors malfunctions, the vehicle is equipped with unpowered safe landing systems which are described in detail after main embodiment operations, the systems having exponentially increased technical ratings.

This alternate version estimated measurements while fully loaded are approximately 3,500 kg. (7,600 lbs.) gross weight, length of almost 11 m. (33 ft.), width approaching 2.6 m. (8 ft.), and height to cabin roof top about 2.8 m. (9.5 ft.), the scaled dimensions maintaining compatibility with road transit operations, infrastructures and regulations Highly versatile, very adaptive cabin capacity can be reconfigured by removing the aft four seats, that space accommodating emergency services and rescue functions special cargo or elevated structures utility maintenance and others.

### Operation

Operation of the invention is detailed according to three dimensional envelopes of the craft traversed environments of road, airspace, and transitions between them. Approach and departure within urban areas can be done with operator use of GPS navigation devices, stored electronic maps or good knowledge of the intended cities in order for pilot-driver to have landmark visual references. Potential multiple sites and alternatives should be established in advance to ensure available ground clearance areas for vehicle landing, and presence of unobstructed vertical corridor needed during both ascent and descent. Avoidance of delays and traffic jams is enabled by directing the aircraft outside of main roadway arteries particularly around rush hours and choosing landing spots as close to destination as possible.

Nighttime and adverse weather conditions are dealt with by activation of lighting equipment, medium range radar, drainage openings and estimating needed clearance sites to double or triple the sizes of the regular parameters from daytime based clear visual readings, or from electronic sensorial ranges and craft proximity detectors.

VTOL operations relating specifically to urban airspace environments (since they are the most technically and navigationally demanding, also with physical limitations and regulatory agencies restrictions being applied) are certain to be capable in zones of: industrial yards or nearby recreational parks; medium size parking lots or on their peripherals; waterfront access roads; bridge heads pre-leading ramps; sports stadiums parking lots; tall buildings roof tops; and on or close by conventional helipads among others. Also approach and departure aerial trajectories should be performed via low elevation to ground at reduced velocities for safe and accurate transitions from one mode to the other. Maneuvers within a city limits for medium or large distances from one point to another are recommended to follow a ‘fly jumping ’ protocol of VTOL actions, with a projected pathway between the sites of an indirect manner, in a parallel line inside the fly zones central path or flying aside main speedways in visual mode to eliminate road bound constrictions and to comply with fly zones regulations.

The VTOL Lifting Body Flying Automobile is equipped with unpowered safe landing systems for engine(s) failure situations.

These technologies are highly reliable of proven performance, are applied in new ways and adapted from current NASA and US Airforce aircrafts. They relate to rabatable flight stabilizing surfaces, ejection seat based minirockets, impact absorbing hydraulic telescopes and inflatable airbags. In their initial passive state all components are stored compactly inside the fuselages and according to the sources cited in ‘Description of Prior Art’ section have small sizes with low weights, are stable during regular craft operations and require little maintenance since are activated only in case of emergency.

Rabatable surfaces are units of two tail fins and two fore panels which are described in the above section of fuselage structures and are shown with their initial state of locations, positions and orientations in FIGS. 1A, 1B, 1C. A set of four minirockets are ‘off the shelf’ fixed devices employed in pilot ejection seats, with fore fuselage placed two units, each facing forward downwardly at a 15 degrees angle and about 45 degrees laterally from vertical axis. Two aft placed thrusters face aftward and downward with each opening oriented close to 45 degrees from vertical axis, also directed with lateral diagonal vectors. All orifices have removable cover caps ending at fuselage surfaces and are held in place by conventional devices such as clamps. Inside the three wheels masts are located hydraulic telescopes of variable pressure transfer, their positions being stored compactly in retracted state and use conventional processes and functions.

Three airbags of high grade material are stored plied inside cartridges which connect by rotary devices to dual points pivotable thin rods. One end of each rod is connected to one cartridge and the other end to a fuselage based structural mount, also a midsection attachment is joined to individual air bags enclosures back side by a retracted state spring mechanism. The sets of bags containers and bars are resting in cavities integrated into fuselage outer surfaces, not protruding the craft aerodynamic profile and their rest state orientations are lengthwise close to vehicle bottom side, being held in place by conventional locking devices.

### Operation of Emergency Systems

Operation of the emergency safe landing systems is detailed with accompanying images.

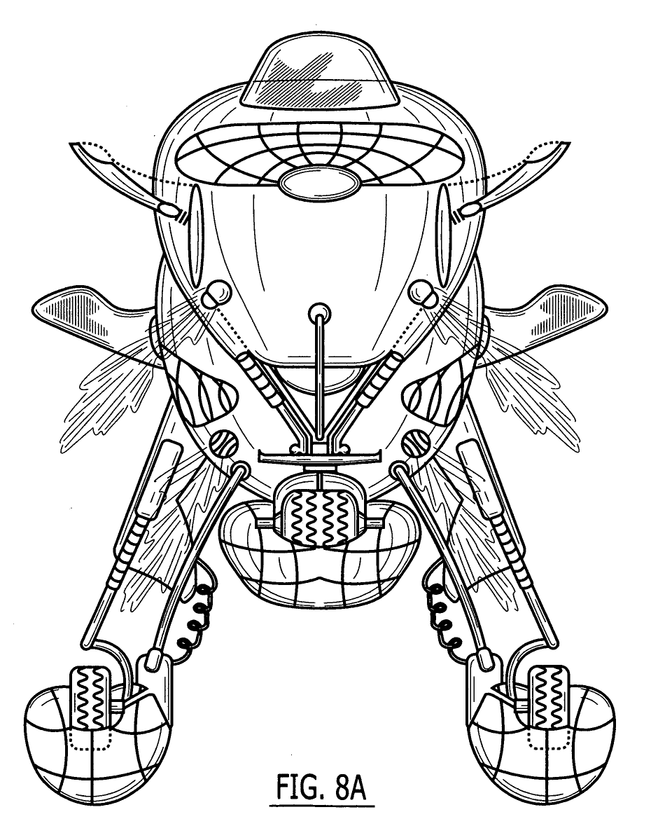

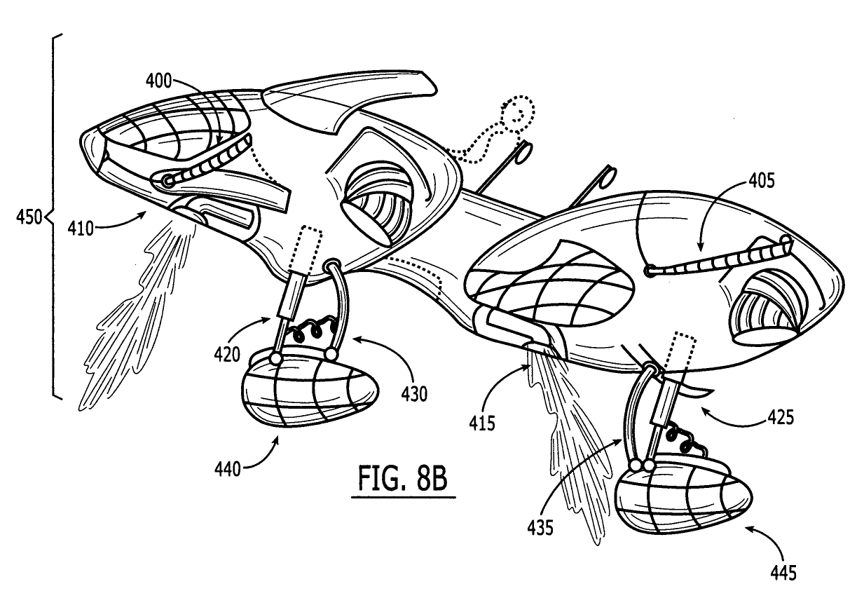

The rabatable stabilizers function as guiding panels in order to both increase aircraft lifting ability and more importantly to provide a forward elongated descent trajectory from vertical drag forces. Two of fore section panels move upward and outward with arched connectors FIGS. 8A, 8B from their aft located mobile points 400 and around fixed positions but pivotable attachments of their forward tips. These movements are performed by conventional elements and actuators having preestablished limits of range and trajectory and position each panel in an angle of almost 30 degrees forward incidence to the horizontal plane, automatically locking rigidly into place. Surfaces angular formation between transversal edge of outer orientation to the inner edge toward fuselage is approximately 30 degrees upward from the horizontal plane, thus the structures are placed in a continuous profile when fully deployed.

The two tail fins displace downward with forward connecting points tracing fuselage sides grooved in tracks, and having fixed positions but rotational terminals 405 on their aftward attachments. Displacements are performed by mobile conventional members with side rolling trajectories and position each fin in an alignment of almost 15 degrees forward incidence to horizontal plane, possessing the devices to rigidly and automatically lock into places. Individual panels angular formation between transversal outer edge to the fuselage inner edge is approximately 15 degrees divergence from horizontal plane, thus orienting within a single plane each deployed structure.

Function of the minirockets is based on three different sequences which are summarized at the end of this section, all components involved in these systems being of conventional functions.

Each sequence is initiated by its separate device, beginning with fuselage located cover caps that dispense externally, ignition stage activated 410, 415 by self contained rocket motors elements and burn time frame for each thruster lasting around 3 seconds. The burn stage is predetermined by mechanism specifications of composition, amount of propellant used, combustion rate for thruster parameters, all being conventional structures and processes and the rating of individual motors approaching production of about 16% per second of kilogram force from aircraft gross weight for a total duration of about 3 seconds. Minirockets motors are of low impulse class using solid propellant for its stability and are ‘off the shelf’ technologies as mentioned above, having proven to be highly safe and reliable, compact and commercially available from manufacturers of pilot egress systems.

Activation of telescopic hydraulic wheels struts is done by predetermined conventional implements. Mechanisms proximal to storage masts compartments push outward a first stage cylinder and about halfway in egress, a second stage part starts to emerge from the first one. These tubular units continue to be released proportionally until first telescope is about 1 ft. extended from its housing and the second element extends to a range approaching 1 ft. from preceding member terminal 420, 425 the second stage connecting to the wheel axial hub by fixed curved bars as displayed. Aft wheels are equipped each with one set of these variable mechanisms and frontal wheel has two lateral sets as shown in drawings. Load transfer rating for a pair of deployed shock absorption cylinders approximates a 16% ratio of craft gross weight.

Operation of the inflatable airbags begins with security devices releasing the thin arms stored externally in molded fuselage cavities. These rods aftward ends are swung in a curved downward 430, 435 manner by actuators from forward rolling terminals, their fixed locations with variable positions being attached underneath fuselage. Outer trajectory ends carry with them from same locations by pivotable devices the cartridges containing initially packed airbags, also the rods midpoints are attached to cartridges with retracted springs which due to their swinging become released. These discharge components push downward the airbags containers to predetermined locations near the deployed telescopic wheels central hubs which present hook and ring type mounts, so that at full extension the cartridges lock onto the hubs attachments. At this point preset triggers initiate bags inflations 440, 445 from containers exposed openings, the cushions shapes and orientations being of shown ovoidal details and surround the lower half of each wheel tire due to expansions trajectories. Individual airbags deployed ratings approaches 6% of aircraft gross weight of kilogram force impact sustained.

Three different sequences of emergency systems activations for safe landing involve three separate control buttons or flips with individual connections to electronic time delay devices that engage same common transmissions and actuators of all described technical components. Sequences use conventional fully automated devices and are initiated based on aircraft altitude at the time of engine(s) or rotors failure, the processes completion providing the aircraft with an landing approach vector 450 that is stable while maintaining safe rapports between craft position and orientation.

Sequence of high elevation above 200 ft. activates first the aft minirockets, followed by fore section rabatable stabilizers, third are fore rockets together with aft gliding fins, ending with all telescopic struts and inflatable airbags, the time lapse between each step being about one second.

Sequence of medium elevation under 200 ft. begins with aft rabatable surfaces, seconded by aft minirockets simultaneously with fore variable surfaces, followed by fore section minithrusters then the hydraulic telescopes and airbags, having half the time delays from above.

Sequence of low altitude below 100 ft. provides no time lapses thus triggering simultaneously all rockets, hydraulic mechanisms and the cushions without movements of the variable panels.

Steering during unpowered descent is enabled by the front traction wheel whose parts are connected to controls, not to propulsive elements. Frontally deployed airbag is articulated to wheel lateral hubs and has different cross directional shapes, its surfaces orientations between forward and lateral directions forming asymmetrical angles as seen in figures. Movements of established controls as during craft regular steering turn the wheel toward one side or the other horizontally thus shifting one lateral surface of the cushion to face same orientation. The differential aerodynamic incidence between forward and lateral sides of airbag produces different drag effects during aircraft trajectory of forward descent. In addition to steering by inflatable members side turning, the maneuvers can be enhanced with operator leaning his torso in the aimed lateral for a partial load displacement effect as in turning a motorcycle.

Optionally the aircraft can have other emergency situations configurations or crash worthiness means. Conventional parachutes are ineffective regardless of number of units used due to inadequacies when deployed on an aircraft at altitudes below 200 ft., slow steering and clear ground needed for operations that require large areas both vertically and horizontally thus not compatible to structures around urban environments. Also this type of device single dynamics does not provide variation for back up technology in case of failure, nor can resistance surface decelerators save their craft or occupants during approach and departure maneuvers at low velocities below 100 ft. elevation with the current state of their known characteristics.

The described safe landing systems are optimal in their dual back up roles and diverse working processes. When all four technologies are functioning as presented without other interfering factors, the vehicle is engineered to have a touch down forward direction velocity around 1.5 m/s (5 ft/s.) without major damages to structures nor to its occupants. In case of half of these mechanisms or subunits malfunctions, either the descent ratio is still reduced to about 50% from a free fall or craft is capable of sustaining close to half of its weight in impact kilogram force, giving occupants the highest capacity of survival for similar conditions than any other commercially present devices or combinations. The rabatable units and minirockets serve dual actions of significant deceleration of craft vertical descent and forward prolonged trajectory impulse with safe positioning for prelanding, while the hydraulic telescopes and inflatable cushions provide ground impact back ups during progressive shocks absorptions.

### Description of Controls

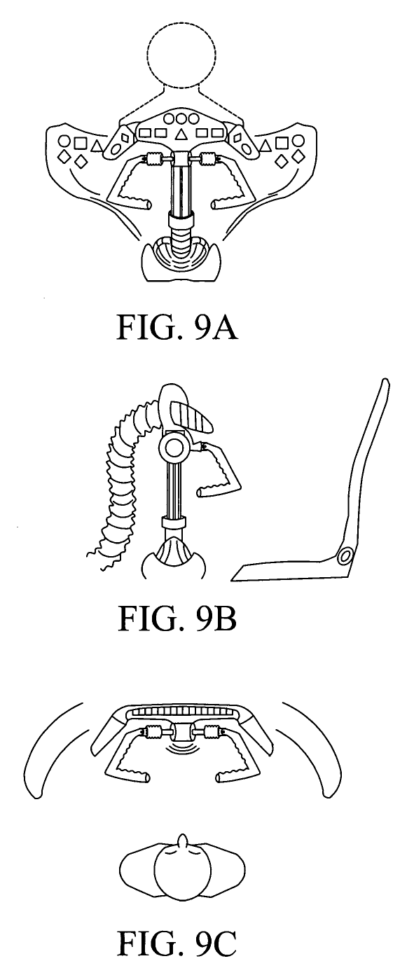

The invention is the easiest to handle in the general aircrafts and Flying Automobiles classes due to its highly intuitive control dynamics and simple input mechanisms. Original controls of central forward configuration displayed in FIGS. 9A, 9B, 9C comprise a ‘ram’ shaped dual locations grip bars oriented in slopes on left and right sides, also in approaching horizontal manner towards the pilot-driver. The handle bars and their sequential components have three dimensional movements connected to three separate primary transmissions located on a central vertical pole, whose momentum is then transferred to secondary stage transmissions of conventional devices placed partially inside a bottom mast and the rest continuing underneath the feet resting floor board.

Primary transmissions have a top member that spins on the vertical axis only, a lower placed member rotating radially in the longitudinal plane around the transversal axis, and a bottom end body with transversal plane roll motions on longitudinal axis.

Two throttles are equipped for dual roles of both fuel feeding variations and triggering rotor heads gear boxes engagements, above the horizontal ‘t’ bar being provided an ergonomically mobile critical instruments only display panel with variable connections to the main fixed dashboard, optionally this feature can be eliminated by integration into the fixed panel. A central horizontal cylinder between the two throttles surrounds conventional separate and commoner engagements for fuel injection control and gears shift couplings. Attached vertically to horizontal tube are three hollow conduits which innerly house the wiring from top cylinder, and outerly contact circular elements of all transmissions that enclose these bars.

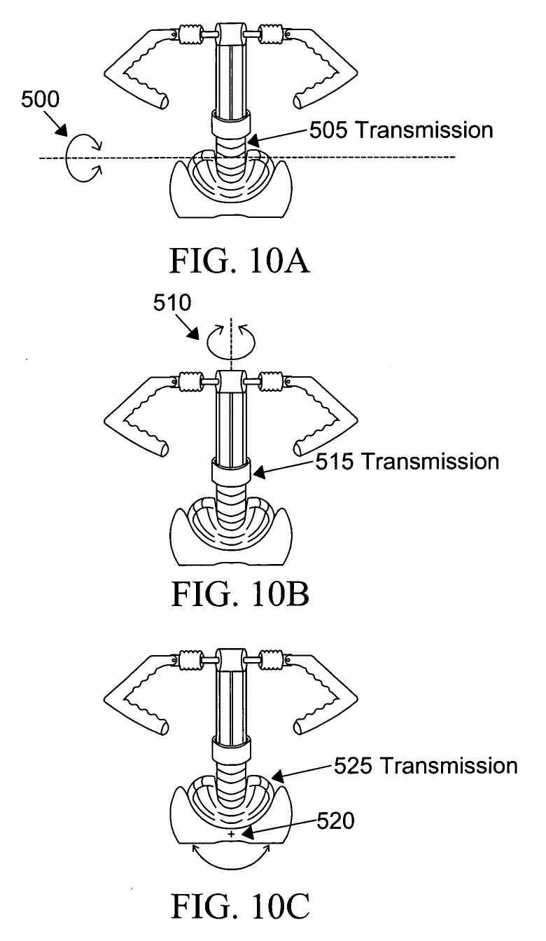

Primary momentum transfer bodies are shown in FIGS. 10A, 10B, 10C having one top rim shaped section with self center spins 510, 515, a main almost cylindrical body located below with curved 500, 505 trajectories, and a principal segment at the base shaped mostly as letter ‘u’ with upward opening of transversally facing frame 520, 525 which rolls laterally. These three primary conveying members are formatted with independent motions from each other and consist of conventional structures.

The horizontal tube located between the throttles contains two sets of trigger devices, each set corresponding to one throttle and consisting of three different helically placed protrusions. These small elements match molded inner slots in the throttles structures, are mobile in the longitudinal vertical plane and each unit sets off one of the three gear sizes from the engine rotor head gear box, with initial gear ratio on each of the two rotor shafts being at medium setting.

Throttles aftward spinning when positioned adjacent to central tube engages the triggers to shift in small gear, while spinning them forward at same location initiates gears shift to large size. When in contact with the tube lateral openings movements of fuel feed grips continue to affect fuel injection rate as in their original mode of efferent position, in the tube afferent contact one additionally influencing the gear ratio changes by engaging different size parts and thus altering rotor shafts RPM. From the horizontal tube are connected three vertical conduits, the central member containing two wire lines for each throttle common engagement of rotor head gears variable couplings control. The other two vertical members contain individually left side, respectively right side conventional transmittal means from the variable grips to engine fuel feed actuators.

Controls components affecting vehicle acceleration and deceleration as described have two positions each with an original setting at transversal extremity where being spun forward decreases fuel rate and when spun aftward increases it by a predetermined rate. If dual engines are employed, left grip controls fore engine while right unit the aft engine. The second position of these grips is the slided placement towards central midpoint of ‘t’ structures joining, having automatic couplings that slide the other throttle even if only one is handled for that setting and is enabled due to continuous mobile attachments between the grips which are activated by either one trajectory. At this location both members contact the mechanisms of the central tube inner placements by its sideways access openings.

### Operation of Controls

Function of control mechanisms, their subsequently connected main systems and resulted vehicle handling are now described based on three types of environmental conditions of: road transport, aerial maneuvers, and critical situations of dive recoveries.

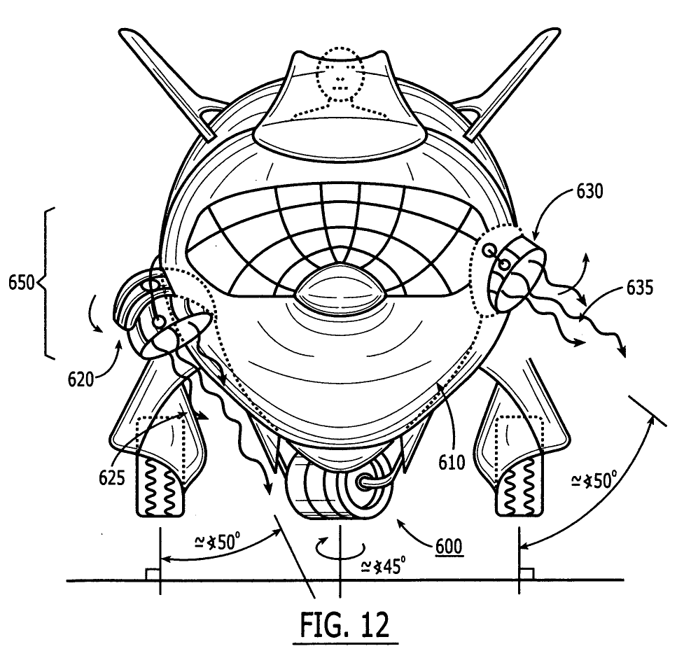

Road transit operations FIGS. 12, 13, 14 begin with unlocking handles position and after engine priming starting ignition, all done by conventional processes.

Thrust is achieved by controls being pulled aftward, throttles spun aft for increased fuel feed, corresponding transmission rotates the same as the controls, actuators move only the longitudinal spinning nozzles in parallel formations, nozzles openings get oriented 720, 725 aftward, outflows vectors push the craft in their opposite aimed direction.

Breaking is obtained with controls pushed forward, throttles rolled aft for faster deceleration or moved fore if prolonged duration is intended, the specific transmission rotates identically as controls, actuators spin all longitudinal outports in parallel alignments, the four outports openings face forward, outflows 700, 705 aim is below craft nose level and result in vehicle slowing down its momentum.

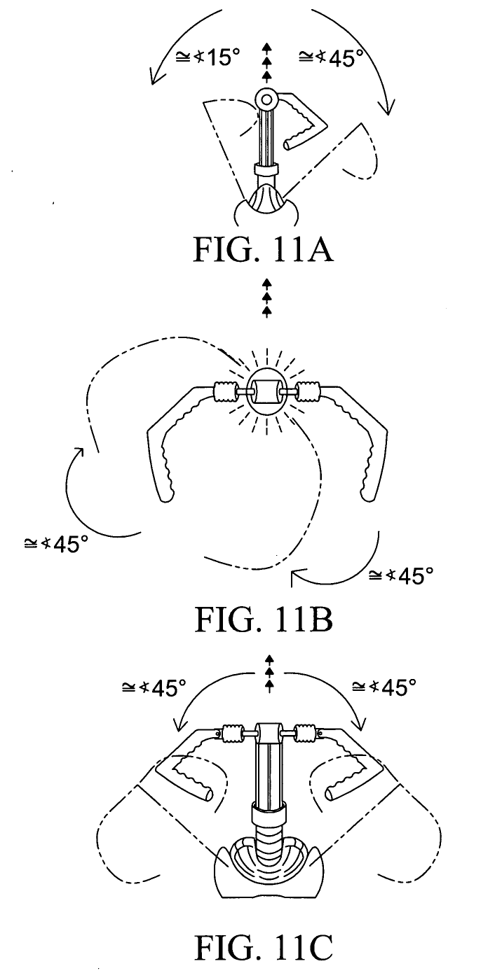

Steering is performed by having handles rotated horizontally toward left or right side of vehicle FIG. 11B; fuel regulating grips rolled aft for tighter cornering or fore if an elongated turning radius is allowed; the primary momentum transfer member rotates as the handles do; a separate set of nozzles moving mechanisms (engaged only by the steering sequence, as specified in description section) roll the two transversal outports laterally and also their longitudinal paired units due to variable but continuous engagements between them; exitflows structures set (of synchronized pairs from fore section) 620, 625 located on same side as the approaching handle move downward transversally while the two exitflows units on the side 630, 635 of handle departing end move upward in unison; airflows from the two openings have almost same angles thus pushing the vehicle 610 fore section in the opposite side of their aims; and the frontal wheel 600 having variable connections to above transmission is rotated towards one side or another with the same range differential as handles movements, resulting in ground traction towards that direction.

Flight operations comprise about half of the maneuvers being very similar to the road based processes.

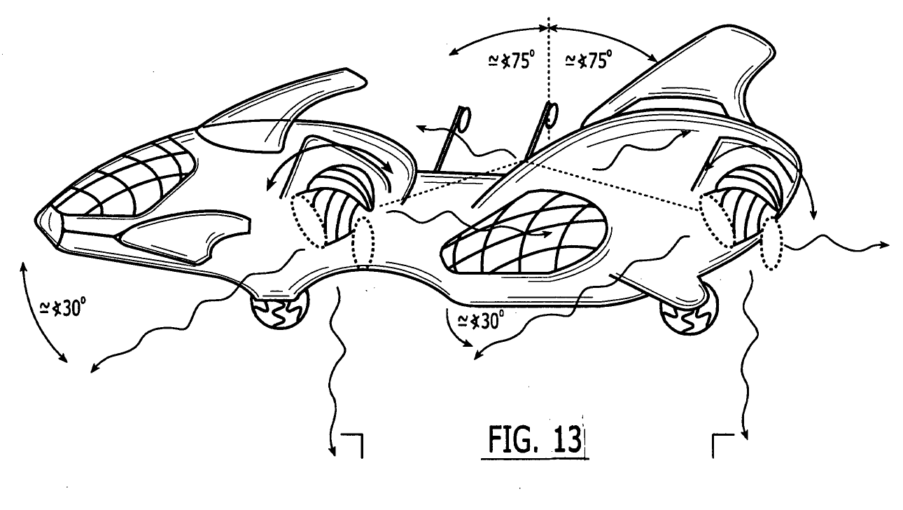

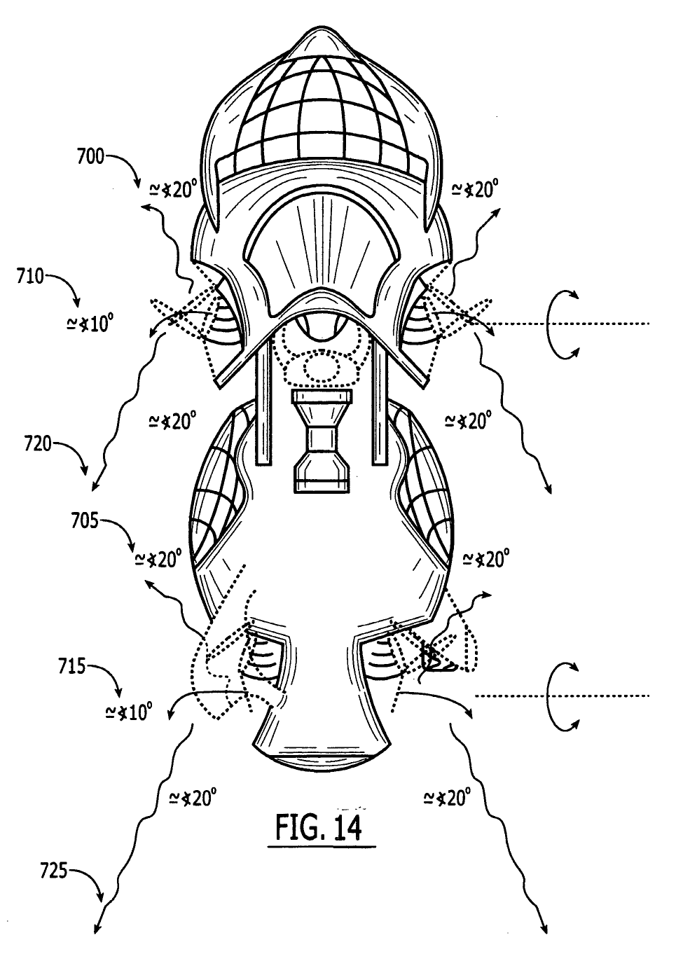

VTOL is performed FIGS. 13, 14 with controls aligned to vertical axis FIG. 11A, throttles rotated aft to increase propellers RPM for ascent and rotated fore during descent, transmissions have almost perpendicular orientations in neutral as the controls, actuators are in their initial state of rest, nozzles active in these maneuvers are the four outmost placed ones 710, 715 of longitudinal spins with openings facing downward at angles approaching vertical axis in parallel formations, outflows vectors depending upon fuel feed rate settings produce ascension, hover and descent of aircraft.

Thrust is achieved in the same way and by the components as in road transport mode, except that propellers RPM settings are increased in order to accommodate craft lifting capacity and higher horizontal velocities.

Breaking is done in almost identical manner to the ground operation, the difference being application of higher fuel flow rate from the grips, or shifting to small gear size.

Steering is effectuated by the components and actions from road functions, having the addition of left side throttle positioned at its transversal extremity and being rolled aftward a few times or cycles according to preestablished settings connected to frontal rotor shaft RPM ratios.

Counter-roll and roll recovery FIG. 11C also FIG. 12 are executed when an transversal impulse becomes critical to craft position or orientation endangering balance and safety.

The protocols to be followed involve handles being spun on vertical transversally towards the lateral opposite of the progressing roll momentum; fuel injection variation elements rotated aftward for increased propellers activity; transmission moves identical to controls; actuators sets (as in description section, provided separately for roll functions) activated by above transmission and contacting only the four primary nozzles of transversal trajectories rotate laterally in synch; transversally circulating outports (from both fore and aft sections that are located on the aircraft side which the controls turn towards) roll downward and push in same direction their paired outer units, while the nozzles from opposite lateral of craft fore and aft locations roll upward transversally and pull in same direction the longitudinally paired members with a constant angular rapport between the two sides; exitflows from ports openings are close to parallel orientations in the same general direction 650, thus the compounded vectors effectuate vehicle turning around its longitudinal axis towards the other side of outflows aim and opposite the initial roll side.

Recovery from nose dive FIG. 13 proceeds with controls being pushed forward as in breaking maneuver but past predetermined mark into a provided fore segment contingency limit, throttles spun aft for higher propellers speed, transmission involved is the same from breaking but with the additional range for contingency motion, actuators of only aft outports having corresponding contingency spaces are engaged by the transmission momentum, nozzles of vehicle aft section rotate from an angle below the longitudinal axis to one above it, outflows from aft openings are directed forward above craft nose level.

The compounded effects of exitflows vectors together with temporary displacement of sustained lift from aft fuselage causes this segment to drop towards fore fuselage level and induce craft horizontal alignment, then enabling reengagement in normal flight procedures.

Recovery from tail dive begins with handles pulled aftward as in thrust mode past preestablished setting into allocated contingency limit (the opposite but equal process of nose dive recovery), fuel rate initiator grips being turned aft, the motion conveying member is the one from regular thrust function with additional contingency space, terminal couplings of craft fore nozzles are provided with additional range for movements according to transmission momentum, outports from only fore fuselage rotate from an alignment close to craft longitudinal axis to an upward angle above tail level, and exitflows from fore openings are directed aftward above tail end.

The factors of flows contingency setting directions combined with temporary removal of lift capacity from fore fuselage result in aircraft nose level approaching aft fuselage position and thus aircraft gains horizontal orientation at which time are resumed regular aerial maneuvers.

Additional variable control surfaces can be integrated into the existing fixed structures or multiple miniorifices for outflows different vectors can be provided to deal with emergency situations, but they go beyond the scope of this presentation.

Superiority of described controls systems is based on their simplified dynamics, ergonomic structures and highly intuitive handling directions corresponding to closely matching craft trajectories. Contributing to these optimal characteristics is the configuration of all hand activated parts (without foot components) making it easy to access, coordinate and keep track of them.

Also the controls being located within a single visual field place significantly less mental strain on the operator as compared to aircrafts of multiple initiating elements having different locations in various dimensional planes which demand a high degree of attention.

The invention provides ease of navigation due to mobility of partial instruments panel and fixed curved dashboard, giving the navigator an equal radial line of sight for displays monitoring which complements the convenience of having any maneuver capable of being controlled by the use of a single hand movements.

One of the highest levels of pilot-driver comfort is achieved by vehicle flight and road operations being closely similar, about half the handling actions involving almost identical processes in both environmental envelopes.

Caused by the optimal controls procedures having close compatibility to vehicle resulting directions, the skills (including training time and efforts for acquiring them) needed to operate this VTOL automobile are of medium level, those of a car driver added to a few more abilities than the ones required for motorcycle riding.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What I claim is:

1-12. (canceled)

13. A motor vehicle comprising:
(a) an aircraft fuselage shape of dual mostly ovoidal sections joined by a cylinder like mid section with half section indentations as seen in a top view, an apple like siluette in the front view, and resembling a shark profile with the bottom surface middle part curved upward as seen from it's side;
(b) a plurality of air flow intake openings compactly built into the fuselage surface having orientation of forward divergent edges, upward obtuse angles and dual laterals of three directional geometry resembling a fish's bended body capable of in taking complex airflow vectors;
(c) a configuration of flight stabilizing surfaces of front fuselage placed vertically oriented dual panels connected to fuselage laterally, and a letter V shape dual fins placed on fuselage tail having forward edges located farther transversally than the fin(s) aft edges with their root attachments to fuselage provided with hollow spaces for un-obstructed air flows passing;
(d) a formation of multiple pairs of swiveling nozzles located on the upper lateral sides of vehicle and being placed longitudinally towards the aft ends of each of the two ovoidal fuselage sections, each nozzle of mostly barrel shape with one opening connected sideways by transversally moving conventional rotational means to vehicle's outer surface away from the inner powerplant structure, and each following paired nozzle unit connected to it's preceding one by longitudinal spin conventional motion means thus the manner of the out ports rotating on vehicle's both lateral and longitudinal axes enables exiting air flow to be directed in 3D with angular ranges close to 120 degrees in each physical plane;
(e) a set of Department Of Motor Vehicles standards compliant sedan type apparatus having outerly placed equipment, together with a power plant contained inside vehicles fuselage body that is connected longitudinally to dual rotor shafts which have attached propelling surfaces in provided separately aft intake half covered compartments, including a 3 sided optional convertible cabin compatible to a tricycle vehicle propulsion conventional technological platform, whereby the mashine can operate fully on urban roads that have minimum of six feet's width.

14. An alternate embodiment to claim 13 comprises:
(a) a vehicle of scaled dimensions from the main embodiment of claim 13 accomodating six ocupants wherein the mashine maintains compatibility to road transport operations and to VTOL capabilities,
(b) an adaptive cabin configuration allowing removal by predetermined inter-changeable processes of aft placed four seats and refitting for other non passenger occupying uses.

15. A VTOL vehicle provided with the flight elements as recited in claim 13 whereby they provide lifting abilities during horizontal flight and lower descent rate in downward trajectories, said apparatus being provided with a size fitting to average road lanes of minimum six feet's width, and producing optimal aerodynamics effects of reduced drag and increased stability during vehicle's aeriai l maneuvers, with 3D thrust vectoring outport structures and means including VTOL abilities thus rendering the machine capable of transiting directly in vertical manner to and from road environments to aerial flight operations.

16. A VTOL vehicle whose road transport equipment of claim 13 features of three tractional wheels and collision protection multiple bars that is enabling functionally on public roads including accident handling capability, good ground support on both laterals, balancing the machine while the shapes and placements of said parts produce low drag during vehicle in air craft mode.

17. A VTOL vehicle as recited in claim 13 having automobile elements for road transport and air craft characteristics wherein said apparatus has dimensions and compact outer structures fitting on one lane logistics and has the means for uninterrupted VTOL transitions between ground and airspace environments thereby the craft being a vertical take off and landing flying personal motor vehicle.
